(19) United States
(12) Patent Application Publication
(10) Pub. No.: US 2025/0281856 A1
(43) Pub. Date: Sep. 11, 2025

(54) LIQUID FILTRATION CARTRIDGE AND A SYSTEM FOR LIQUIED FILTRATION

(71) Applicants: William S Roche, Casselberry, FL (US); Owen Boyd, Westport, MA (US)

(72) Inventors: William S Roche, Casselberry, FL (US); Owen Boyd, Westport, MA (US)

(21) Appl. No.: 18/599,196

(22) Filed: Mar. 8, 2024

(51) Int. Cl. B01D 27/08; B01D 29/21

(52) U.S. Cl. CPC B01D 27/08; B01D 29/21; B01D 2201/291; B01D 2239/1216

(57) ABSTRACT

The present disclosure provides a filter cartridge, a filtration system and a process for filtering and or treatment of water for residential, industrial and/or medical purposes. Referring to FIGS. 1 and 2, there is shown a filter cartridge (10) comprising: (a) a vessel (16) comprising a first cavity; (b) a filter media (14) having a second cavity disposed in said vessel thereby forming a first compartment therebetween an outer surface of said filter media and an inner surface of said vessel; (c) a central core (15) comprising a first solid porous material disposed in said second cavity; (d) at least one water treatment media disposed in a cavity in said first solid porous material; (e) a blocking core (17) comprising a porous blocking material; (f) a first end cap (18) attached to a first end of said vessel (16), wherein said first end cap (18) is optionally configured to form a first outlet (22); and (g) a second end cap (24) attached to a second end of said vessel (16), wherein said second end cap (24) is optionally configured to form a second outlet (25).

### FIELD OF THE INVENTION

The present disclosure relates to a liquid filtration cartridge, a system for liquid filtration and/or treatment, and process for filtering and/or treatment of liquids.

### BACKGROUND OF THE INVENTION

Filtration systems are widely applied in industrial production and daily life and are often used for filtration of various fluids. With the improvement of living standards, filtration systems are widely used in the filtration of water for use in residential, medical, and industrial settings to eliminate contaminants or microorganisms; thus, ensuring the water use safety. Various filter types may be used to remove harmful substances or microorganisms. Such filters include sediment filters, activated carbon filters, ultrafiltration hollow fiber membrane filters, reverse osmosis membrane filters, and the like. However, the current available commercial systems fail to provide cartridge and a system for optimum filtration and treatment of water.

### SUMMARY OF THE INVENTION

The present disclosure provides a filter cartridge, a filtration system and a process for filtering and or treatment of water for residential, industrial or medical purposes.

In one embodiment, the present disclosure provides a filter cartridge (10) comprising: (a) a vessel (16) comprising a first cavity; (b) a filter media (14) having a second cavity disposed in said vessel thereby forming a first compartment therebetween an outer surface of said filter media and an inner surface of said vessel; (c) a central core (15) comprising a first solid porous material disposed in said second cavity; (d) at least one water treatment media disposed in a cavity in said first solid porous material; (e) a blocking core (17) comprising a porous blocking material; (f) a first end cap (18) attached to a first end of said vessel (16), wherein said first end cap (18) is optionally configured to form a first outlet (22); and (g) a second end cap (24) attached to a second end of said vessel (16), wherein said second end cap (24) is optionally configured to form a second outlet (25).

In an alternative embodiment, the present disclosure provides a filtration system comprising: (a) a pressurized water source (not shown) providing pressurized water; (b) a housing (30), (c) a filter cartridge (10) comprising: (a) a vessel (16) comprising a first cavity; (b) a filter media (14) having a second cavity disposed in said vessel thereby forming a first compartment therebetween an outer surface of said filter media and an inner surface of said vessel; (c) a central core (15) comprising a first solid porous material disposed in said second cavity; (d) at least one water treatment media disposed in a cavity in said first solid porous material; (e) a blocking core (17) comprising a porous blocking material; (f) a first end cap (18) attached to a first end of said vessel (16), wherein said first end cap (18) is optionally configured to form a first outlet (22); and (g) a second end cap (24) attached to a second end of said vessel (16), wherein said second end cap (24) is optionally configured to form a second outlet (25); and (vii) a second end cap (17) attached to a second end of said vessel (16), wherein said second end cap (17) is optionally configured to form a second outlet (21), and wherein said filter cartridge (10) is disposed in said housing (30). Housing (3) further comprises an inlet (34) and outlet (32). Outlet (32) is configured to connect and create a seal with first outlet (22).

In an alternative embodiment, the instant invention provides a process for filtering and treating water comprising the steps of: (a) providing a filtration system comprising; (A) a pressurized water source (not shown) providing pressurized water; (B) a housing (30); (C) a filter cartridge (10) comprising: (a) a vessel (16) comprising a first cavity; (b) a filter media (14) having a second cavity disposed in said vessel thereby forming a first compartment therebetween an outer surface of said filter media and an inner surface of said vessel; (c) a central core (15) comprising a first solid porous material disposed in said second cavity; (d) at least one water treatment media disposed in a cavity in said first solid porous material; (e) a blocking core (17) comprising a porous blocking material; (f) a first end cap (18) attached to a first end of said vessel (16), wherein said first end cap (18) is optionally configured to form a first outlet (22); and (g) a second end cap (24) attached to a second end of said vessel (16), wherein said second end cap (24) is optionally configured to form a second outlet (25); and (b) channeling said pressurized water via said one or more openings through the filter media (14) into and through said central core (15), wherein said pressurized water comes into contact with said water treatment media and then is directed into and through blocking core (17) and then channeled out of said filter cartridge (10) via said first outlet (16).

### BRIEF DESCRIPTION OF DRAWINGS

For the purpose of illustrating the invention, there is shown in the drawings a form that is exemplary; it being understood, however, that this invention is not limited to the precise arrangements and instrumentalities shown.

FIG. 1 is a first embodiment of a filter cartridge;

FIG. 1a is a bottom view first embodiment in FIG. 1;

FIG. 1b is a top view first embodiment in FIG. 1;

FIG. 2 is a second embodiment of a filter cartridge;

FIG. 2a is a bottom view first embodiment in FIG. 2;

FIG. 2b is a top view first embodiment in FIG. 2;

FIG. 3 a perspective view of a filter cartridge housing;

FIG. 4 a side view of a filter cartridge housing;

FIG. 5 a longitudinal cross-sectional view of a filter cartridge disposed in the housing;

FIG. 6 a longitudinal cross-sectional view of a filter cartridge disposed in the housing illustrating the water flow;

FIG. 7 is an exploded view of a filter cartridge disposed in the housing;

FIG. 8 is another exploded view of a filter cartridge disposed in the housing;

FIG. 9 is a perspective view of a second embodiment of a filter cartridge;

FIG. 9a is a bottom view of a second embodiment of a filter cartridge;

FIG. 10 is a perspective view of a first embodiment of a filter cartridge;

FIG. 10a is a bottom view of a first embodiment of a filter cartridge;

FIG. 11 is an exploded view of a second embodiment of a filter cartridge;

FIG. 12 is an exploded view of a first embodiment of a filter cartridge;

FIG. 13 a longitudinal cross-sectional view of a first embodiment of a filter cartridge;

FIG. 14 a longitudinal cross-sectional view of a second embodiment of a filter cartridge; and

FIG. 15 a cross-sectional view of a filter cartridge.

### DETAILED DESCRIPTION OF THE INVENTION

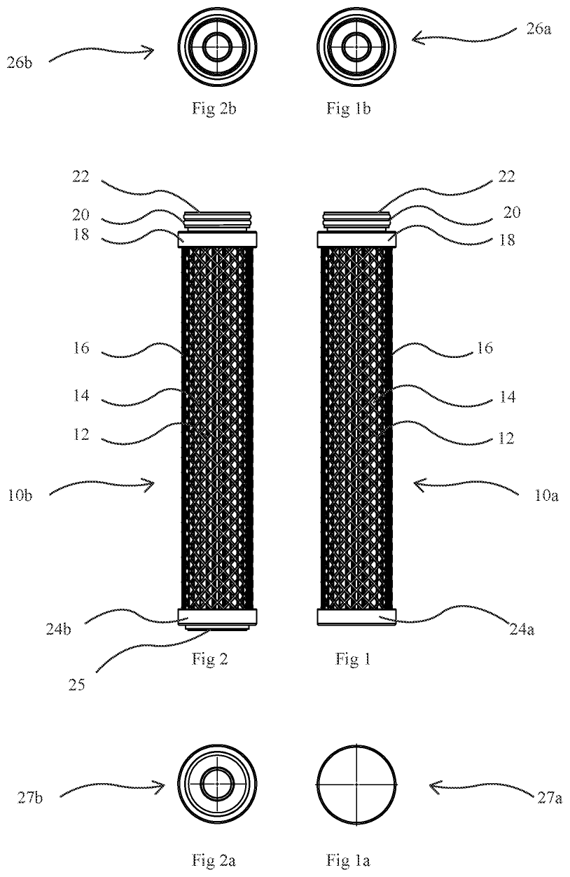

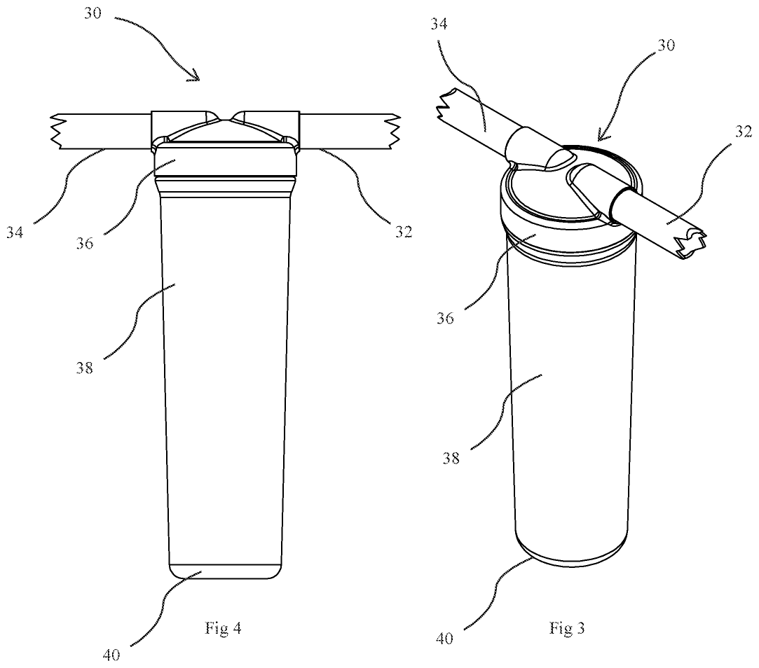

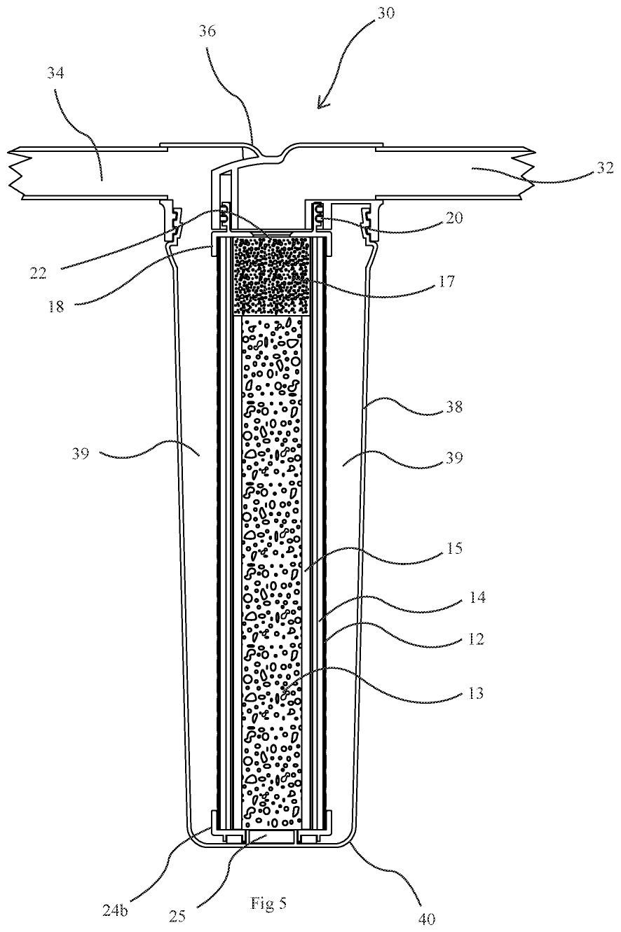

The present disclosure provides a filter cartridge, a filtration system and a process for filtering and or treatment of water for residential, industrial and/or medical purposes. Referring to FIGS. 1 and 2, there is shown a filter cartridge (10) comprising: (a) a vessel (16) comprising a first cavity; (b) a filter media (14) having a second cavity disposed in said vessel thereby forming a first compartment therebetween an outer surface of said filter media and an inner surface of said vessel; (c) a central core (15) comprising a first solid porous material disposed in said second cavity; (d) at least one water treatment media disposed in a cavity in said first solid porous material; (e) a blocking core (17) comprising a porous blocking material; (f) a first end cap (18) attached to a first end of said vessel (16), wherein said first end cap (18) is optionally configured to form a first outlet (22); and (g) a second end cap (24) attached to a second end of said vessel (16), wherein said second end cap (24) is optionally configured to form a second outlet (25). The first outlet can optionally extend outwardly and can further comprise one or more O-rings (24). The second outlet can have a gasket, which is optionally configured to form a seal with the bottom portion of the housing.

The vessel can comprise any materials. For example, the vessel can comprise a protective mesh material. In the alternative, the vessel can comprise a polymeric material formed into an injection molding housing comprising one or more openings. In one embodiment, the filter media is coupled to the first end cap and the second end cap thereby forming a filtration path through the one or more openings through the filter media into and through the central core and then into and through blocking core and then out of the filter cartridge via the first outlet.

The filter media is a filtration material having a pore size in the range of 0.9 to 1.8μ nominal. In one embodiment, the filter media is pleated, and in an alternative embodiment, filter media is flat and preferably in a tubular shape. The filter media can have any thickness, for example the filter media can have a thickness in the range of from 1 mm to 2 mm. In one embodiment, the filter media is hydrophobic. In one embodiment, the filter media is capable of removing particles having a diameter in the range of less than 800μ, for example, less than 400μ, or less than 200μ, or less than 100μ, or less than 10μ, or less than 1μ.

The filter media is capable of withstanding a pressure in the range of up to 120 psi, for example, the filter media is capable of withstanding a pressure in the range of 10 to 80 psi, for example 60 psi (nominal). The filter media is also capable of removing substantial portion of bacteria, virus, cysts, and combinations thereof, for example, the filter media is capable of removing at least 99.99% of the bacteria, virus, cysts and combinations thereof. Such filter media is commercially available from Ahlstrom under the trade name Ahlstrom Disruptor 5288.

The water treatment media can be any material, in one embodiment the water treatment media is selected from the group consisting of iodine, silver, ion exchange resin, carbon, combinations thereof, and the like. The water treatment media comprises a solid composition. The water treatment media can comprise a powder, beads or the line. The first solid porous material can be a material; for example, the first solid porous material is selected from the group consisting of a synthetic material, a natural material, combinations thereof, and the like. In one embodiment, the first solid porous material is selected from the group consisting of a porous polymeric material, a porous carbon block, combinations thereof, and the like. The first solid porous material can have an average pore size in the range of from 5 micron to 250 microns pore size.

The porous blocking material can be any material; for example, the porous blocking material is selected from the group consisting of a synthetic material, a natural material, combinations thereof, and the like. The porous blocking material has an average pore size in the range of from 5 micron to 250 microns pore size.

In an alternative embodiment, referring to FIGS. 3, 4, 5, & 7, the present disclosure provides a filtration system comprising: (a) a pressurized water source (not shown) providing pressurized water; (b) a housing (30), (c) a filter cartridge (10) comprising: (a) a vessel (16) comprising a first cavity; (b) a filter media (14) having a second cavity disposed in said vessel thereby forming a first compartment therebetween an outer surface of said filter media and an inner surface of said vessel; (c) a central core (15) comprising a first solid porous material disposed in said second cavity; (d) at least one water treatment media disposed in a cavity in said first solid porous material; (e) a blocking core (17) comprising a porous blocking material; (f) a first end cap (18) attached to a first end of said vessel (16), wherein said first end cap (18) is optionally configured to form a first outlet (22); and (g) a second end cap (24) attached to a second end of said vessel (16), wherein said second end cap (24) is optionally configured to form a second outlet (25); and (vii) a second end cap (17) attached to a second end of said vessel (16), wherein said second end cap (17) is optionally configured to form a second outlet (21), and wherein said filter cartridge (10) is disposed in said housing (30).

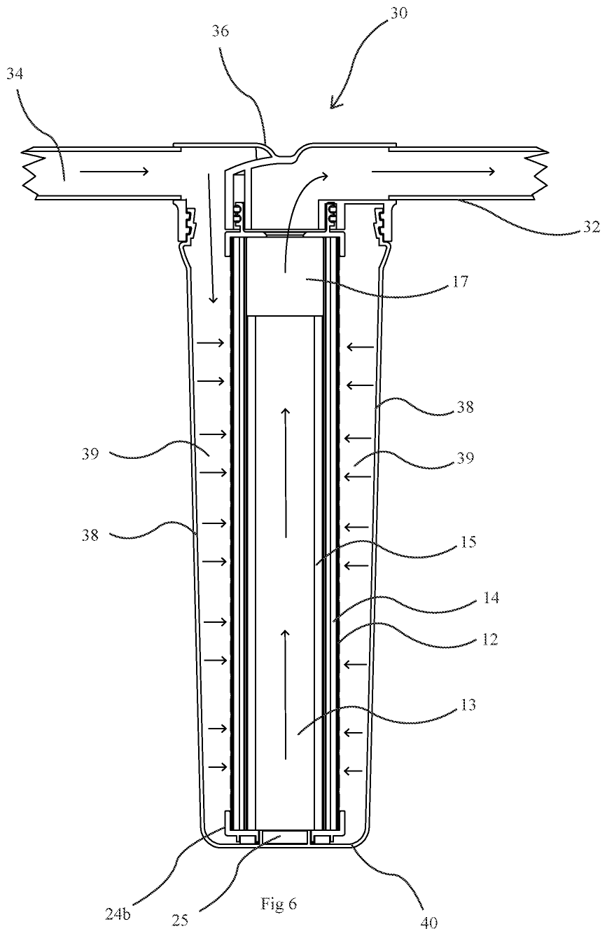

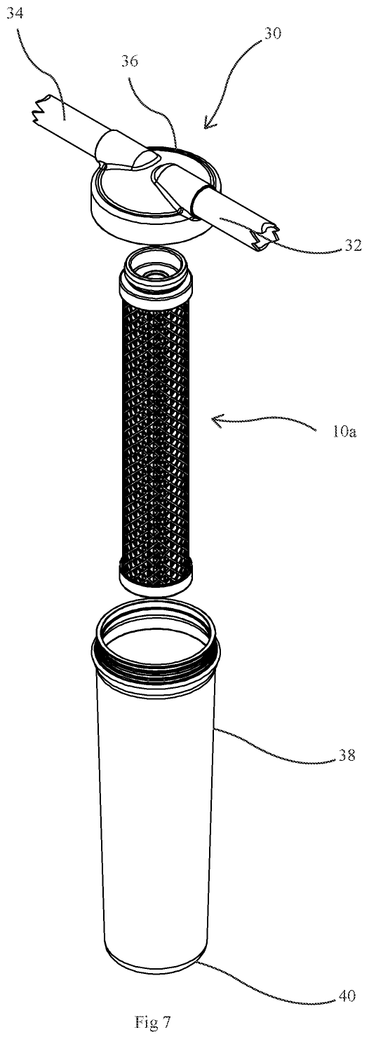

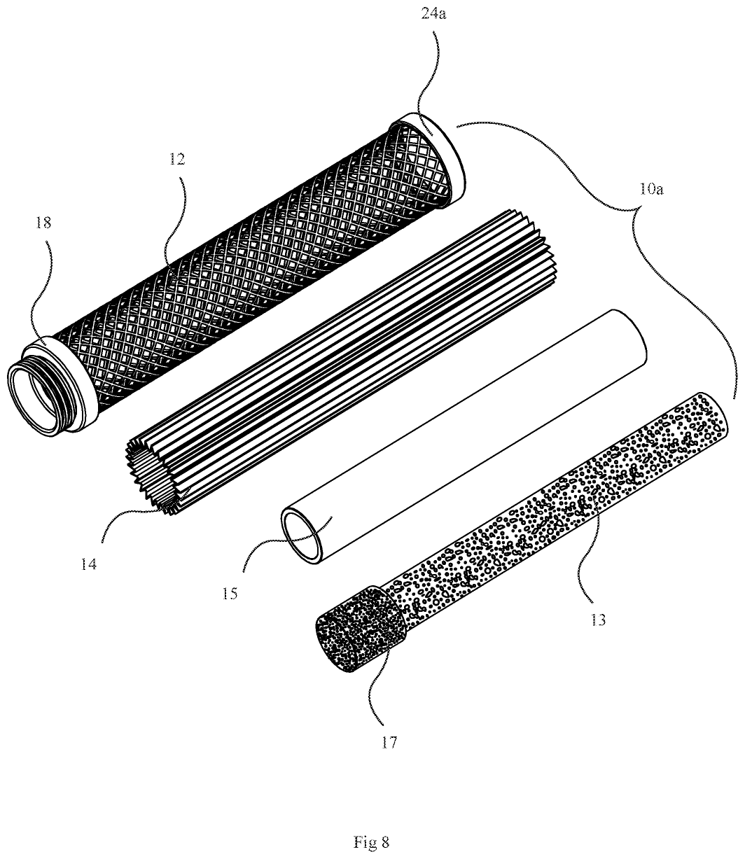

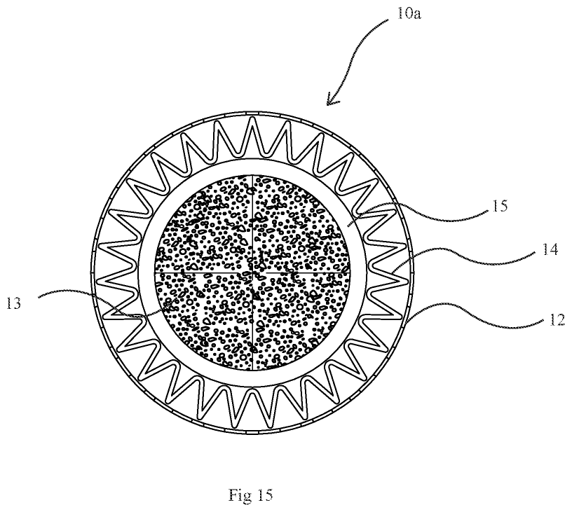

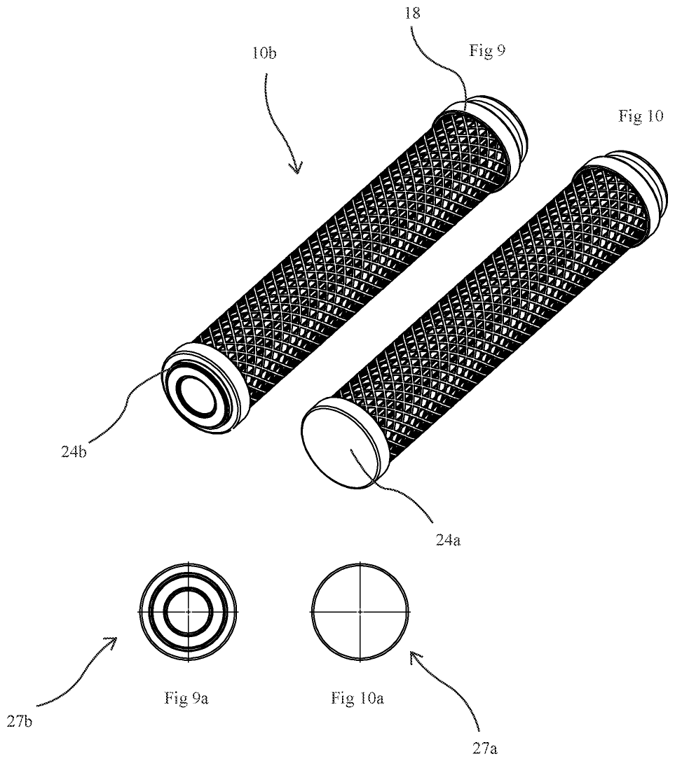

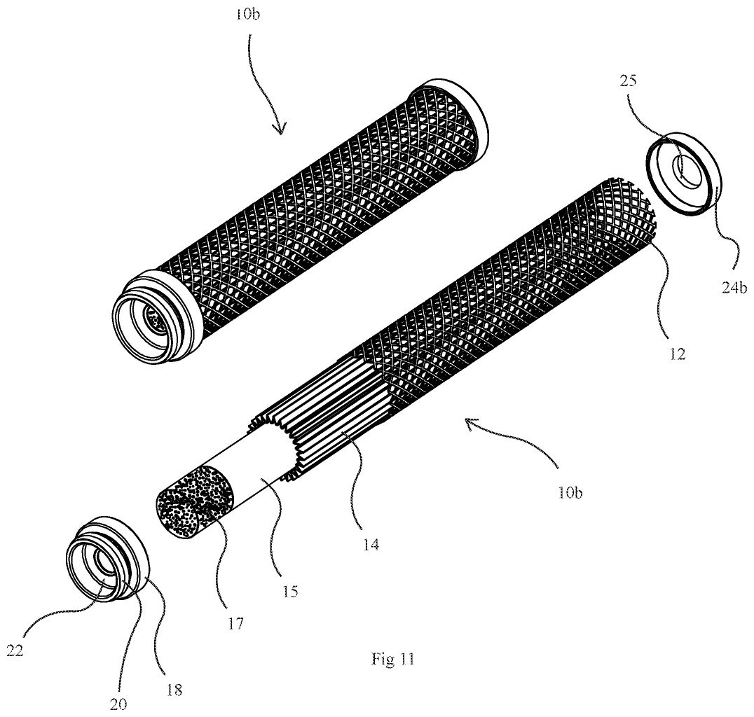

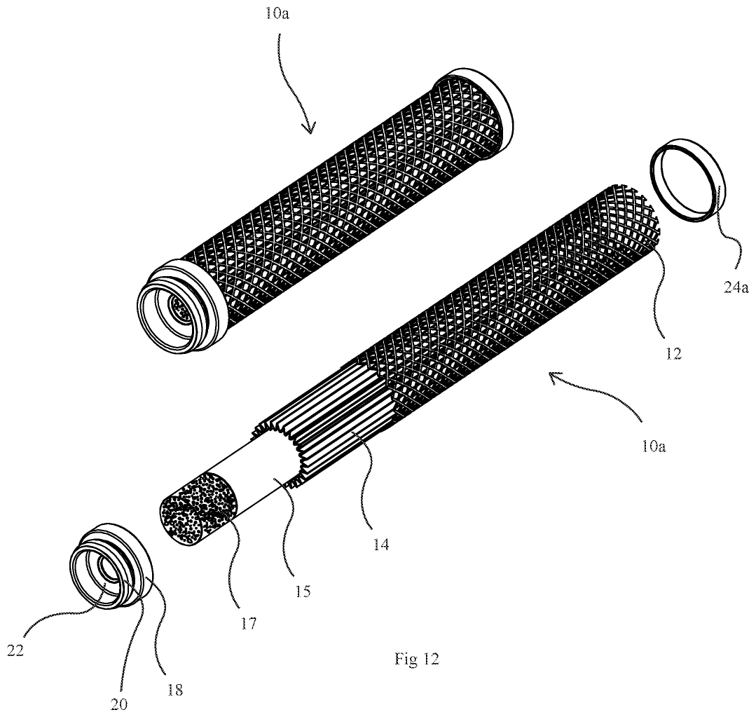

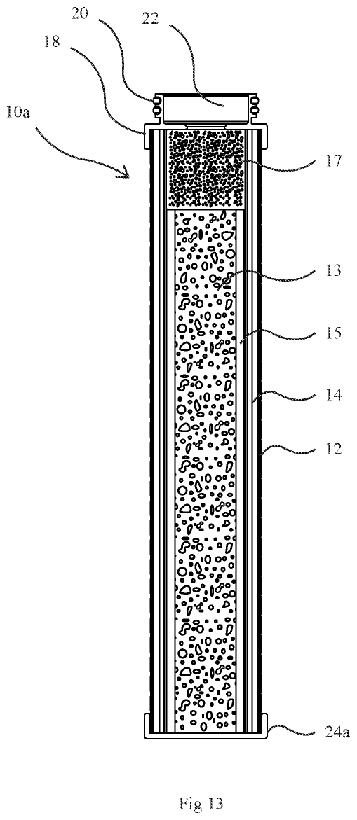

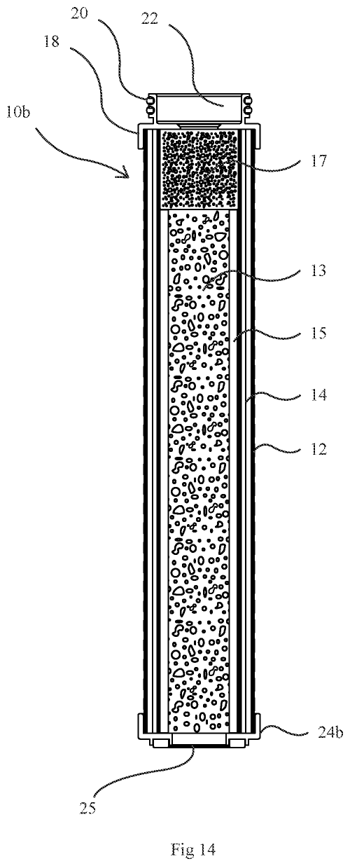

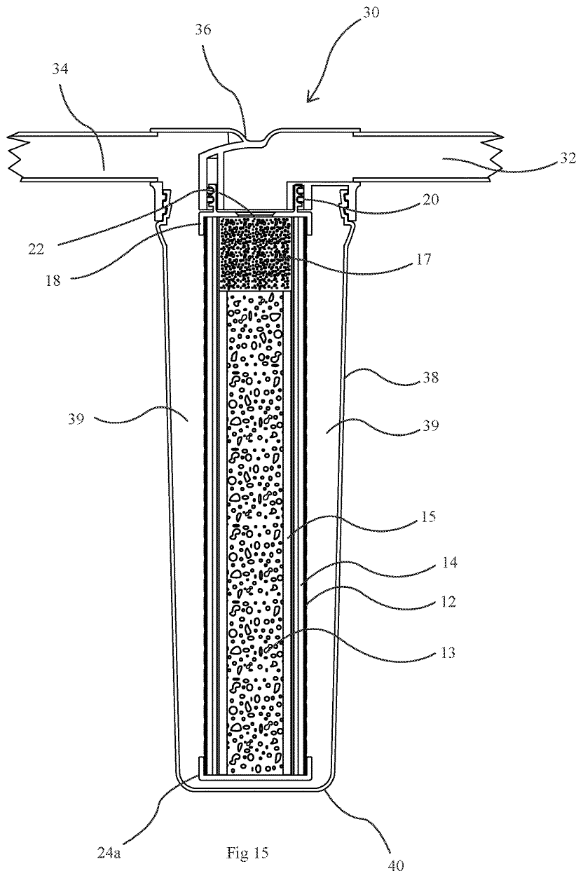

In an alternative embodiment, referring to FIG. 6, the instant invention provides a process for filtering and treating water comprising the steps of: (a) providing a filtration system comprising; (A) a pressurized water source (not shown) providing pressurized water; (B) a housing (30); (C) a filter cartridge (10) comprising: (a) a vessel (16) comprising a first cavity; (b) a filter media (14) having a second cavity disposed in said vessel thereby forming a first compartment therebetween an outer surface of said filter media and an inner surface of said vessel; (c) a central core (15) comprising a first solid porous material disposed in said second cavity; (d) at least one water treatment media disposed in a cavity in said first solid porous material; (e) a blocking core (17) comprising a porous blocking material; (f) a first end cap (18) attached to a first end of said vessel (16), wherein said first end cap (18) is optionally configured to form a first outlet (22); and (g) a second end cap (24) attached to a second end of said vessel (16), wherein said second end cap (24) is optionally configured to form a second outlet (25); and (b) channeling said pressurized water via said one or more openings through the filter media (14) into and through said central core (15), wherein said pressurized water comes into contact with said water treatment media and then is directed into and through blocking core (17) and then channeled out of said filter cartridge (10) via said first outlet (16).

The present invention may be embodied in other forms without departing from the spirit and the essential attributes thereof, and, accordingly, reference should be made to the appended claims, rather than to the foregoing specification, as indicating the scope of the invention.

We claim:

1. A filter cartridge comprising:
a) a vessel comprising a first cavity;
b) a filter media having a second cavity disposed in the vessel thereby forming a first compartment therebetween an outer surface of said filter media and an inner surface of the vessel;
c) a central core comprising a first solid porous material disposed in the second cavity;
d) at least one water treatment media disposed in a cavity in the first solid porous material;
e) a blocking core comprising a porous blocking material;
f) a first end cap attached to a first end of the vessel, wherein the first end cap is optionally configured to form a first outlet; and
g) a second end cap attached to a second end of the vessel, wherein the second end cap is optionally configured to form a second outlet.

2. The filter cartridge of claim 1, wherein the vessel comprises a protective mesh material.

3. The filter cartridge of claim 1, wherein the filter media is pleated.

4. The filter cartridge of claim 1, wherein the filter media is tubular shape.

5. The filter cartridge of claim 1, wherein the filter media has thickness in the range of 1 mm to 2 mm.

6. The filter cartridge of claim 1, wherein the filter media is hydrophobic.

7. The filter cartridge of claim 1, wherein the filter media has a pore size in the range of 0.9 to 1.8 micron nominal.

8. The filter cartridge of claim 1, wherein the filter media is capable of removing particles having a diameter in the range of less than 1 micron and more than one micron.

9. The filter cartridge of claim 1, wherein the filter media is capable of withstanding a pressure in the range of up to 120 psi.

10. The filter cartridge of claim 1, wherein the filter media is capable of removing substantial portion of bacteria, virus, cysts, and combinations thereof.

11. The filter cartridge of claim 4, wherein the filter media is coupled to the first end cap and the second end cap thereby forming a filtration path through said one or more openings through the filter media into and through the central core and then into and through blocking core and then out of the filter cartridge via the first outlet.

12. The filter cartridge of claim 1, wherein said water treatment media is selected from the group consisting of iodine, silver, ion exchange resin, carbon, combinations thereof, and the like.

13. The filter cartridge of claim 1, wherein said first solid porous material is selected from the group consisting of a synthetic material, a natural material, combinations thereof, and the like.

14. The filter cartridge of claim 1, wherein said first solid porous material is selected from the group consisting of a porous polymeric material, a porous carbon block, combinations thereof, and the like.

15. The filter cartridge of claim 1, wherein the first solid porous material has an average pore size in the range of from 5 micron to 250 microns pore size.

16. The filter cartridge of claim 1, wherein the porous blocking material is selected from the group consisting of a synthetic material, a natural material, combinations thereof, and the like.

17. The filter cartridge of claim 1, wherein the porous blocking material has an average pore size in the range of from 5 micron to 250 microns pore size.

18. The filter cartridge of claim 1, wherein the outlet extends outwardly and comprises one or more O-rings.

19. A filtration system comprising:
a. a pressurized water source providing pressurized water;
b. a housing;
c. a filter cartridge comprising:
a vessel comprising a first cavity;
a filter media having a second cavity disposed in the vessel thereby forming a first compartment therebetween an outer surface of the filter media and an inner surface of the vessel;
a central core comprising a first solid porous material disposed in the second cavity;
at least one water treatment media disposed in the first solid porous material;
a blocking core comprising a porous blocking material;
a first end cap attached to a first end of the vessel, wherein the first end cap is optionally configured to form a first outlet; and
a second end cap attached to a second end of the vessel, wherein the second end cap is optionally configured to form a second outlet, wherein said filter cartridge is disposed in the housing.

20. A process for filtering and treating water comprising the steps of:
a. providing a filtration system comprising;
a pressurized water source providing pressurized water;
a housing;
a filter cartridge comprising:
i. a vessel comprising a first cavity;
ii. a filter media having a second cavity disposed in the vessel thereby forming a first compartment therebetween an outer surface of the filter media and an inner surface of the vessel;
iii. a central core comprising a first solid porous material disposed in the second cavity;
iv. at least one water treatment media disposed in the first solid porous material;
V. a blocking core comprising a porous blocking material;
vi. a first end cap attached to a first end of the vessel, wherein the first end cap is optionally configured to form a first outlet; and
vii. a second end cap attached to a second end of the vessel, wherein the second end cap is optionally configured to form a second outlet, wherein the filter cartridge is disposed in the housing; and
(C) channeling the pressurized water via the one or more openings through the filter media into and through the central core, wherein the pressurized water comes into contact with the water treatment media and then is directed into and through blocking core and then channeled out of the filter cartridge via the first outlet.
